(19) United States
(12) Patent Application Publication
(10) Pub. No.: US 2022/0114419 A1
(43) Pub. Date: Apr. 14, 2022

(54) CLASSIFICATION DEVICE AND CLASSIFICATION METHOD BASED ON NEURAL NETWORK

(71) Applicant: Industrial Technology Research Institute, Hsinchu (TW)

(72) Inventors: Yu-Shan Deng, Hsinchu County (TW); An-Chun Luo, Hsinchu County (TW); Po-Han Chang, Taichung City (TW); Chun-Ju Lin, Hsinchu County (TW); Ming-Ji Dai, Hsinchu City (TW)

(73) Assignee: Industrial Technology Research Institute, Hsinchu (TW)

(21) Appl. No.: 17/121,763

(22) Filed: Dec. 15, 2020

Related U.S. Application Data
(60) Provisional application No. 63/091,280, filed on Oct. 13, 2020.

(30) Foreign Application Priority Data
Oct. 28, 2020 (TW) 109137445

(51) Int. Cl. G06N 3/04

(52) U.S. Cl. CPC G06N 3/0454; G06N 3/0445

(57) ABSTRACT

A classification device and a classification method based on a neural network are provided. A heterogeneous integration module includes a convolutional layer, a data normalization layer, a connected layer and a classification layer. The convolutional layer generates a first feature map according to a first image data. The data normalization layer normalizes a first numerical data to generate a first normalized numerical data. The first numerical data corresponds to the first image data. The connected layer generates a first feature vector according to the first feature map and the first normalized numerical data. The classification layer generates a first classification result corresponding to a first time point according to the first feature vector. The heterogeneous integration module generates a second classification result corresponding to a second time point. A recurrent neural network generates a third classification result according to the first classification result and the second classification result.

### CROSS-REFERENCE TO RELATED APPLICATION

This application claims the priority benefit of U.S. provisional application Ser. No. 63/091,280, filed on Oct. 13, 2020 and Taiwan application no. 109137445, filed on Oct. 28, 2020. The entirety of each of the above-mentioned patent applications is hereby incorporated by reference herein and made a part of this specification.

### TECHNICAL FIELD

The disclosure relates to a classification device and a classification method based on a neural network.

### BACKGROUND

With the rise of the Internet of things (IoT) technology, more and more users monitor various values of a device by installing various types of sensors on the device. In this way, a large amount of different types of sensing data will be obtained. However, the current machine learning technology cannot train or improve a classification model through the different types of sensing data. Therefore, even if the user collects a large amount of heterogeneous data related to the device, the user is still unable to improve the accuracy of the classification model through the heterogeneous data.

### SUMMARY

The disclosure provides to a classification device and a classification method based on a neural network, which can generate classification results through heterogeneous data.

A classification device based on a neural network of the disclosure includes a heterogeneous integration module and a recurrent neural network. The heterogeneous integration module includes a convolutional layer, a data normalization layer, a connected layer and a classification layer. The convolutional layer generates a first feature map according to a first image data. The data normalization layer normalizes a first numerical data to generate a first normalized numerical data. The first numerical data corresponds to the first image data. The first image data and the first numerical data correspond to a first time point. The connected layer is coupled to the convolutional layer and the data normalization layer, and generates a first feature vector according to the first feature vector and the first normalized numerical data. The classification layer is coupled to the connected layer, and generates a first classification result corresponding to the first image data and the first numerical data according to the first feature vector. The heterogeneous integration module generates a second classification result according to a second image data and a second numerical data corresponding to a second time point. The second numerical data corresponds to the second image data. The recurrent neural network is coupled to the heterogeneous integration module. The recurrent neural network generates a third classification result corresponding to the second image data and the second numerical data according to the first classification result and the second classification result.

In an embodiment of the disclosure, the connected layer concatenates the first feature map and the first normalized numerical data to generate a concatenation data, and generates the first feature vector according to the concatenation data.

In an embodiment of the disclosure, the first normalized numerical data is normalized to a value from 0 to 1.

A classification device based on a neural network of the disclosure includes a heterogeneous integration module and a recurrent neural network. The heterogeneous integration module includes a convolutional layer, a data normalization layer and a connected layer. The convolutional layer generates a first feature map according to a first image data. The data normalization layer normalizes a first numerical data to generate a first normalized numerical data. The first numerical data corresponds to the first image data. The first image data and the first numerical data correspond to a first time point. The connected layer is coupled to the convolutional layer and the data normalization layer, and generates a first feature vector according to the first feature vector and the first normalized numerical data. The recurrent neural network is coupled to the connected layer. The recurrent neural network generates a first classification result corresponding to the first image data and the first numerical data according to the first feature vector. The heterogeneous integration module generates a second feature vector according to a second image data and a second numerical data corresponding to a second time point. The second numerical data corresponds to the second image data. The recurrent neural network generates a second classification result corresponding to the second image data and the second numerical data according to the first feature vector and the second feature vector.

In an embodiment of the disclosure, the connected layer concatenates the first feature map and the first normalized numerical data to generate a concatenation data, and generates the first feature vector according to the concatenation data.

In an embodiment of the disclosure, the first normalized numerical data is normalized to a value from 0 to 1.

A classification method based on a neural network of the disclosure includes: obtaining a first image data and a first numerical data corresponding to a first time point, wherein the first numerical data corresponds to the first image data; obtaining a heterogeneous integration module, wherein the heterogeneous integration module includes a convolutional layer, a data normalization layer, a connected layer and a classification layers; generating a first feature map according to the first image data by the convolutional layer; normalizing the first numerical data to generate a first normalized numerical data by the data normalization layer; generating a first feature vector according to the first feature map and the first normalized numerical data by the connected layer; generating a first classification result corresponding to the first image data and the first numerical data according to the first feature vector by the classification layer; obtaining a second image data and a second numerical data corresponding to a second time point, wherein the second numerical data corresponds to the second image data; generating a second classification result according to the second image data and the second numerical data by the heterogeneous integration module; obtaining a recurrent neural network; and generating a third classification result corresponding to the second image data and the second numerical data according to the first classification result and the second classification result by the recurrent neural network.

In an embodiment of the disclosure, the connected layer concatenates the first feature map and the first normalized numerical data to generate a concatenation data, and generates the first feature vector according to the concatenation data.

In an embodiment of the disclosure, the first normalized numerical data is normalized to a value from 0 to 1.

A classification method based on a neural network of the disclosure includes: obtaining a first image data and a first numerical data corresponding to a first time point, wherein the first numerical data corresponds to the first image data; obtaining a heterogeneous integration module and a recurrent neural network, wherein the heterogeneous integration module includes a convolutional layer, a data normalization layer and a connected layer; generating a first feature map according to the first image data by the convolutional layer; normalizing the first numerical data to generate a first normalized numerical data by the data normalization layer; generating a first feature vector according to the first feature map and the first normalized numerical data by the connected layer; generating a first classification result corresponding to the first image data and the first numerical data according to the first feature vector by the recurrent neural network; obtaining a second image data and a second numerical data corresponding to a second time point, wherein the second numerical data corresponds to the second image data; generating a second feature vector according to the second image data and the second numerical data by the heterogeneous integration module; and generating a second classification result corresponding to the second image data and the second numerical data according to the first feature vector and the second feature vector by the recurrent neural network.

In an embodiment of the disclosure, the connected layer concatenates the first feature map and the first normalized numerical data to generate a concatenation data, and generates the first feature vector according to the concatenation data.

In an embodiment of the disclosure, the first normalized numerical data is normalized to a value from 0 to 1.

Based on the above, the classification device of the disclosure can generate the classification results according to the heterogeneous data. The recurrent neural network in the classification device can improve the classification results by the timing-related.

### BRIEF DESCRIPTION OF THE DRAWINGS

FIG. 1 is a schematic diagram illustrating a classification device based on a neural network according to an embodiment of the disclosure.

FIG. 2 is a detailed schematic diagram illustrating the classification device according to an embodiment of the disclosure.

FIG. 3 is a schematic diagram illustrating classification results generated through timing-related data by the recurrent neural network according to an embodiment of the disclosure.

FIG. 4 is a schematic diagram illustrating a classification device based on a neural network according to another embodiment of the disclosure.

FIG. 5 is a detailed schematic diagram illustrating the classification device according to another embodiment of the disclosure.

FIG. 6 is a schematic diagram illustrating classification results generated through timing-related data by the recurrent neural network according to another embodiment of the disclosure.

FIG. 7 is a flowchart illustrating a classification method based on a neural network according to an embodiment of the disclosure.

FIG. 8 is a flowchart illustrating a classification method based on a neural network according to another embodiment of the disclosure.

### DETAILED DESCRIPTION

In order to make content of the present disclosure more comprehensible, embodiments are described below as the examples to prove that the present disclosure can actually be realized. Moreover, elements/components/steps with same reference numerals represent same or similar parts in the drawings and embodiments.

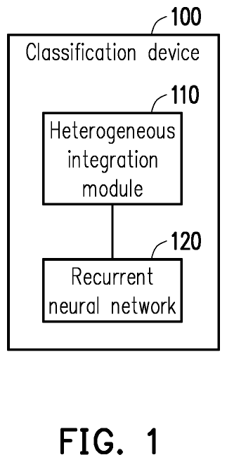

FIG. 1 is a schematic diagram illustrating a classification device 100 based on a neural network according to an embodiment of the disclosure. The classification device 100 may be implemented by hardware or software. For instance, the classification device 100 may be implemented by a circuit or an integrated circuit. As another example, the classification device 100 may be a software module stored in a storage medium. The software module can be accessed and executed by an electronic device (e.g., a processor) with computing capability to realize the function of the classification device 100.

The classification device 100 is, for example, a deep neural network (DNN) capable of integrating heterogeneous data and timing. The classification device 100 can generate classification results according to the heterogeneous data, such as image data and numerical data. For example, the classification device 100 can be used to determine whether a glue outlet of a die bonder is blocked. In detail, the classification device 100 can determine whether the glue outlet of the die bonder is blocked according to an image of the glue outlet and an air pressure value of the glue outlet. For another example, the classification device 100 can be used to determine whether a drug needs to be injected for a patient with macular disease. In detail, the classification device 100 can determine whether to inject the drug for the patient with macular disease according to an optical coherence tomography (OCT) image and basic information of the patient (e.g., age or Landolt C chart test results). The classification device 100 can also be used to verify a sensor function. For example, when a sensor is added to the process line, the classification device 100 can generate a classification result according to a sensing data of the new sensor. The user can determine whether the sensing data of the new sensor is abnormal according to a correctness of the classification result.

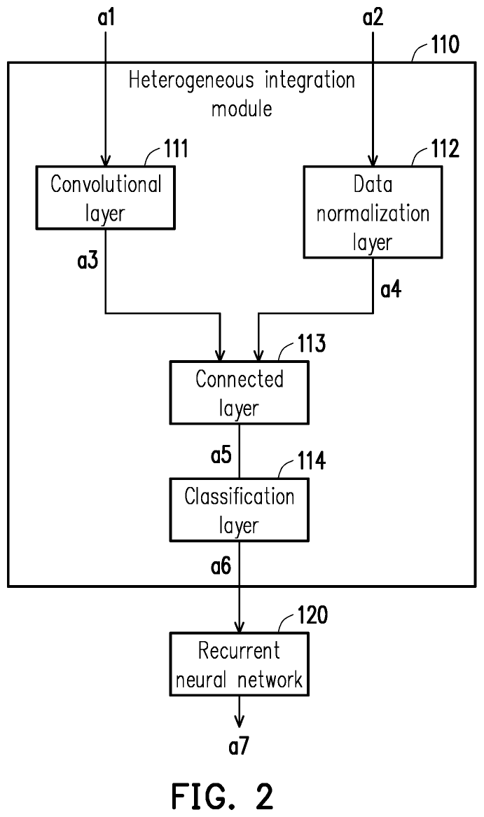

The classification device 100 may include a heterogeneous integration module 110 and a recurrent neural network (RNN) 120. FIG. 2 is a detailed schematic diagram illustrating the classification device 100 according to an embodiment of the disclosure. The heterogeneous integration module 110 may include a convolutional layer 111, a data normalization layer 112, a connected layer 113 and a classification layer (or a fully connected (FC) layer) 114. An input end of the connected layer 113 may be coupled to an output end of the convolutional layer 111 and an output end of the data normalization layer 112. An input end of the classification layer 114 may be coupled to an output end of the connected layer 113.

The convolutional layer 111 may receive an image data a1, and generate (one or more) feature map(s) a3 according to the image data a1. The data normalization layer 112 may receive a numerical data a2 corresponding to the image data a1, and may normalize the numerical data a2 to generate a normalized numerical data a4. In an embodiment, the data normalization layer 112 may normalize the numerical data a2 to a value from 0 to 1, so as to generate the normalized numerical data a4.

The connected layer 113 may generate a feature vector a5 according to the feature map a3 and the normalized numerical data a4. In an embodiment, the connected layer 113 may concatenate the feature map a3 and the normalized numerical data a4 to generate a concatenation data, and generate the feature vector a5 according to the concatenation data. After the feature vector a5 is generated, the classification layer 114 may generate a classification result a6 corresponding to image data a1 and the numerical data a2 according to the feature vector a5.

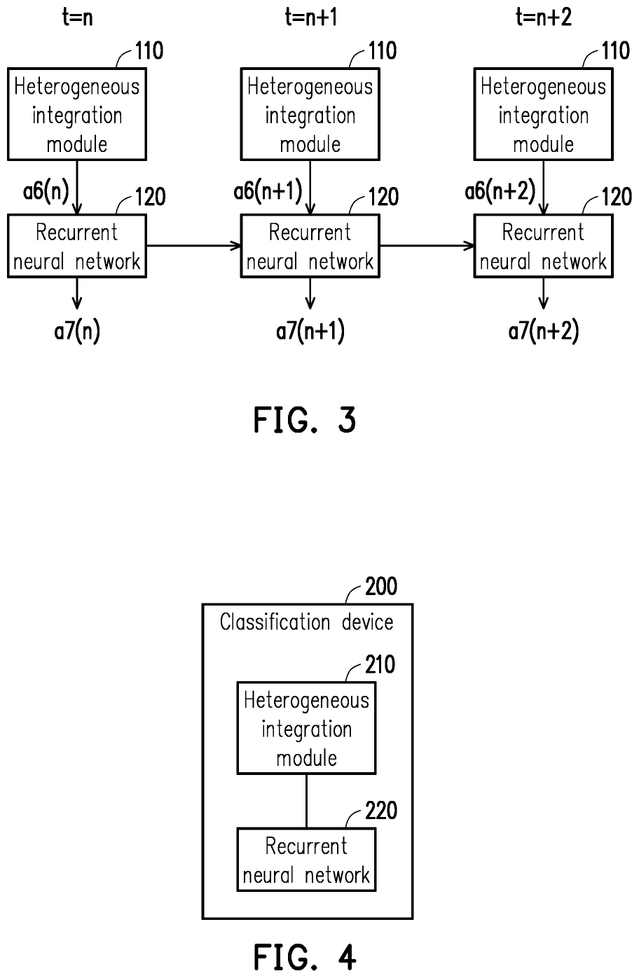

The recurrent neural network 120 may be coupled to the classification layer 114 of the heterogeneous integration module 110. The recurrent neural network 120 may generate a more accurate classification result based on timing-related data (i.e., the classification result) output by the heterogeneous integration module 110. FIG. 3 is a schematic diagram illustrating classification results generated through timing-related data by the recurrent neural network 120 according to an embodiment of the disclosure. In this embodiment, it is assumed that the heterogeneous integration module 110 may generate a classification result a6(n) according to an image data a1(n) and a numerical data a2(n) corresponding to a time point t=n (n is a positive integer), and may generate a classification result a6(n+1) according to an image data a1(n+1) and a numerical data a2(n+1) corresponding to a time point t=n+1. The recurrent neural network 120 may receive the classification result a6(n) and the classification result a6(n+1) from the heterogeneous integration module 110, and generate a classification result a7(n+1) corresponding to the image data a1(n+1) and the numerical data a2(n+1) according to the classification result a6(n) and the classification result a6(n+1).

Based on similar steps, it is assumed that the heterogeneous integration module 110 may also generate a classification result a6(n+2) according to an image data a1(n+2) and a numerical data a2(n+2) corresponding to a time point t=n+2. The recurrent neural network 120 may receive the classification result a6(n+1) corresponding to the time point t=n+1 and the classification result a6(n+2) corresponding to the time point t=n+2 from the heterogeneous integration module 110, and generate a classification result a7(n+2) corresponding to the image data a1(n+2) and the numerical data a2(n+2) according to the classification result a6(n+1) and the classification result a6(n+2).

FIG. 4 is a schematic diagram illustrating a classification device 200 based on a neural network according to an embodiment of the disclosure. The classification device 200 may be implemented by hardware or software. For instance, the classification device 200 may be implemented by a circuit or an integrated circuit. As another example, the classification device 200 may be a software module stored in a storage medium. The processor can access and execute the software module in the storage medium to realize the function of the classification device 200.

The classification device 200 is, for example, a deep neural network capable of integrating heterogeneous data and timing. The classification device 200 can generate classification results according to the heterogeneous data, such as image data and numerical data. For example, the classification device 200 can be used to determine whether a glue outlet of a die bonder is blocked. In detail, the classification device 200 can determine whether the glue outlet of the die bonder is blocked according to an image of the glue outlet and an air pressure value of the glue outlet. For another example, the classification device 200 can be used to determine whether a drug needs to be injected for a patient with macular disease. In detail, the classification device 200 can determine whether to inject the drug for the patient with macular disease according to an optical coherence tomography (OCT) image and basic information of the patient (e.g., age or Landolt C chart test results). The classification device 200 can also be used to verify a sensor function. For example, when a sensor is added to the process line, the classification device 200 can generate a classification result according to a sensing data of the new sensor. The user can determine whether the sensing data of the new sensor is abnormal according to a correctness of the classification result.

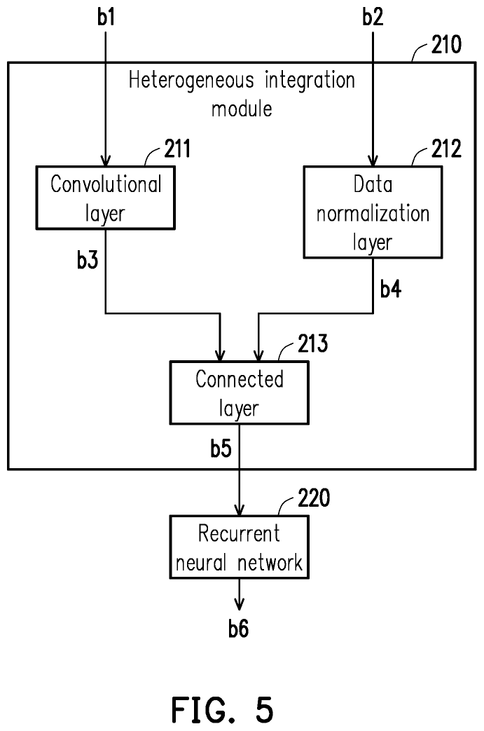

The classification device 200 may include a heterogeneous integration module 210 and a recurrent neural network 220. FIG. 5 is a detailed schematic diagram illustrating the classification device 200 according to another embodiment of the disclosure. The heterogeneous integration module 210 may include a convolutional layer 211, a data normalization layer 212 and a connected layer 213. An input end of the connected layer 213 may be coupled to an output end of the convolutional layer 211 and an output end of the data normalization layer 212.

The convolutional layer 211 may receive an image data b1, and generate (one or more) feature map(s) b3 according to the image data b1. The data normalization layer 212 may receive a numerical data b2 corresponding to the image data b1, and may normalize the numerical data b2 to generate a normalized numerical data b4. In an embodiment, the data normalization layer 212 may normalize the numerical data b2 to a value from 0 to 1, so as to generate the normalized numerical data b4.

The connected layer 213 may generate a feature vector b5 according to the feature map b3 and the normalized numerical data b4. In an embodiment, the connected layer 213 may concatenate the feature map b3 and the normalized numerical data b4 to generate a concatenation data, and generate the feature vector b5 according to the concatenation data.

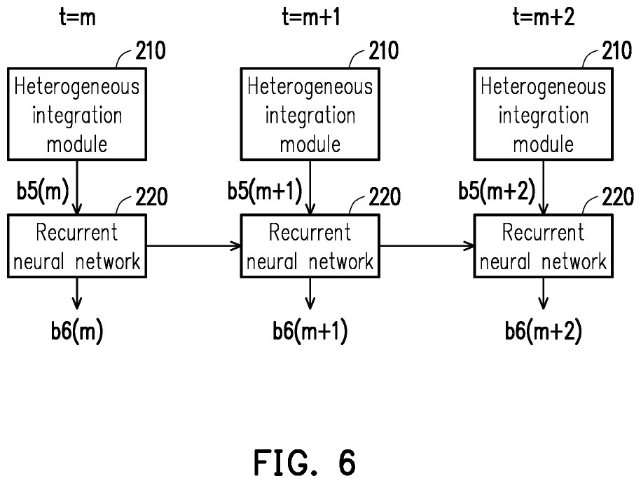

The recurrent neural network 220 may be coupled to the connected layer 213 of the heterogeneous integration module 210. The recurrent neural network 220 may receive the feature vector b5 from the heterogeneous integration module 210, and generate a classification result b6 corresponding to the image data b1 and the numerical data b2 according to the feature vector b5. In an embodiment, the recurrent neural network 220 may generate the classification result corresponding to the image data b1 and the numerical data b2 based on the timing-related data (i.e., the feature vector) output by the heterogeneous integration module 210. FIG. 6 is a schematic diagram illustrating classification results generated through timing-related data by the recurrent neural network 220 according to another embodiment of the disclosure. In this embodiment, it is assumed that the heterogeneous integration module 210 may generate a feature vector b5(m) according to an image data b1(m) and a numerical data b2(m) corresponding to a time point t=m (m is a positive integer), and may generate a feature vector b5(m+1) according to an image data b1(m+1) and a numerical data b2(m+1) corresponding to a time point t=m+1. The recurrent neural network 220 may receive the feature vector b5(m) and the feature vector b5(m+1) from the heterogeneous integration module 210, and generate a classification result b6(m+1) corresponding to the image data b1(m+1) and the numerical data b2(m+1) according to the feature vector b5(m) and the feature vector b5(m+1).

Based on similar steps, it is assumed that the heterogeneous integration module 210 may also generate a feature vector b5(m+2) according to an image data b1(m+2) and a numerical data b2(m+2) corresponding to a time point t=m+2. The recurrent neural network 220 may receive the feature vector b5(m+1) corresponding to the time point t=m+1 and the feature vector b5(m+2) corresponding to the time point t=m+2 from the heterogeneous integration module 210, and generate a classification result b6(m+2) corresponding to the image data b1(m+2) and the numerical data b2(m+2) according to the feature vector b5(m+1) and the feature vector b5(m+2).

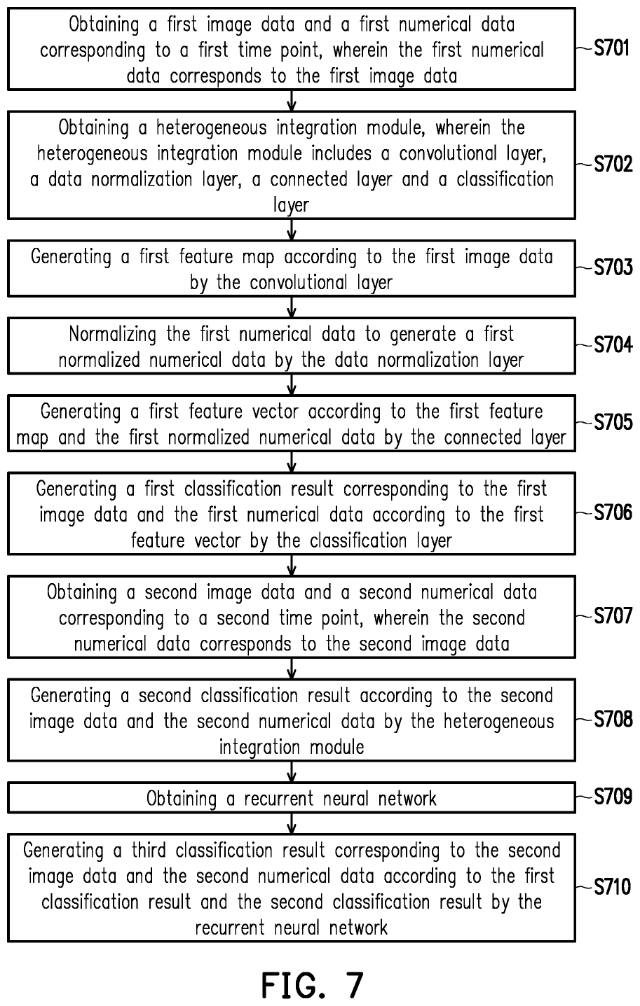

FIG. 7 is a flowchart illustrating a classification method based on a neural network according to an embodiment of the disclosure. The method may be implemented by the classification device 100 shown by FIG. 1. In step S701, a first image data and a first numerical data corresponding to a first time point are obtained, wherein the first numerical data corresponds to the first image data. In step S702, a heterogeneous integration module is obtained, wherein the heterogeneous integration module includes a convolutional layer, a data normalization layer, a connected layer and a classification layer. In step S703, a first feature map is generated according to the first image data by the convolutional layer. In step S704, the first numerical data is normalized to generate a first normalized numerical data by the data normalization layer. In step S705, a first feature vector is generated according to the first feature map and the first normalized numerical data by the connected layer. In step S706, a first classification result corresponding to the first image data and the first numerical data is generated according to the first feature vector by the classification layer. In step S707, a second image data and a second numerical data corresponding to a second time point are obtained, wherein the second numerical data corresponds to the second image data. In step S708, a second classification result is generated according to the second image data and the second numerical data by the heterogeneous integration module. In step S709, a recurrent neural network is obtained. In step S710, a third classification result corresponding to the second image data and the second numerical data is generated according to the first classification result and the second classification result by the recurrent neural network.

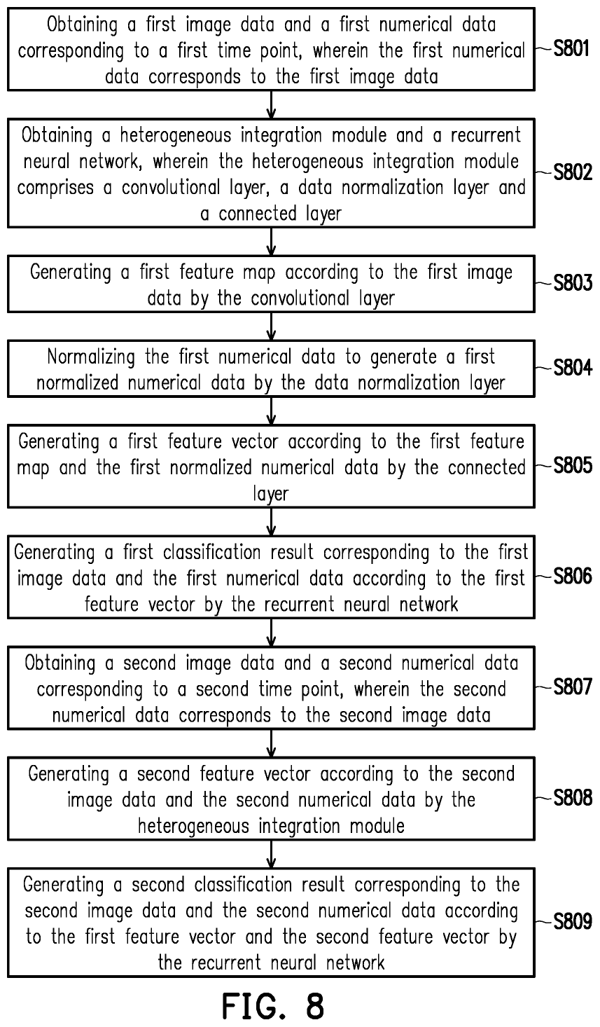

FIG. 8 is a flowchart illustrating a classification method based on a neural network according to another embodiment of the disclosure. The method may be implemented by the classification device 200 shown by FIG. 4. In step S801, a first image data and a first numerical data corresponding to a first time point are obtained, wherein the first numerical data corresponds to the first image data. In step S802, a heterogeneous integration module and a recurrent neural network are obtained, wherein the heterogeneous integration module comprises a convolutional layer, a data normalization layer and a connected layer. In step S803, a first feature map is generated according to the first image data by the convolutional layer. In step S804, the first numerical data is normalized to generate a first normalized numerical data by the data normalization layer. In step S805, a first feature vector is generated according to the first feature map and the first normalized numerical data by the connected layer. In step S806, a first classification result corresponding to the first image data and the first numerical data is generated according to the first feature vector by the recurrent neural network. In step S807, a second image data and a second numerical data corresponding to a second time point are obtained, wherein the second numerical data corresponds to the second image data. In step S808, a second feature vector is generated according to the second image data and the second numerical data by the heterogeneous integration module. In step S809, a second classification result corresponding to the second image data and the second numerical data is generated according to the first feature vector and the second feature vector by the recurrent neural network.

In summary, the classification device of the disclosure can obtain the heterogeneous data including the image data and the numerical data, and generate the classification results based on the heterogeneous data. Compared with the traditional classification technology that only uses the image data, the classification results generated by the disclosed technology are more accurate. On the other hand, the classification device of the disclosure can include the recurrent neural network, which can analyze the timing-related data and use the data to improve the classification results. Therefore, the performance of the classification device will improve over time.

Although the present disclosure has been described with reference to the above embodiments, it is apparent to one of the ordinary skill in the art that modifications to the described embodiments may be made without departing from the spirit of the present disclosure. Accordingly, the scope of the present disclosure will be defined by the attached claims not by the above detailed descriptions.

1. A classification device based on a neural network, comprising:
a heterogeneous integration module, comprising:
a convolutional layer, generating a first feature map according to a first image data;
a data normalization layer, normalizing a first numerical data to generate a first normalized numerical data, wherein the first numerical data corresponds to the first image data, wherein the first image data and the first numerical data correspond to a first time point;
a connected layer, coupled to the convolutional layer and the data normalization layer, and generating a first feature vector according to the first feature vector and the first normalized numerical data; and
a classification layer, coupled to the connected layer, and generating a first classification result corresponding to the first image data and the first numerical data according to the first feature vector, wherein
the heterogeneous integration module generates a second classification result according to a second image data and a second numerical data corresponding to a second time point, wherein the second numerical data corresponds to the second image data; and
a recurrent neural network, coupled to the heterogeneous integration module, wherein the recurrent neural network generates a third classification result corresponding to the second image data and the second numerical data according to the first classification result and the second classification result.

2. The classification device of claim 1, wherein the connected layer concatenates the first feature map and the first normalized numerical data to generate a concatenation data, and generates the first feature vector according to the concatenation data.

3. The classification device of claim 1, wherein the first normalized numerical data is normalized to a value from 0 to 1.

4. A classification device based on a neural network, comprising:
a heterogeneous integration module, comprising:
a convolutional layer, generating a first feature map according to a first image data;
a data normalization layer, normalizing a first numerical data to generate a first normalized numerical data, wherein the first numerical data corresponds to the first image data, wherein the first image data and the first numerical data correspond to a first time point; and
a connected layer, coupled to the convolutional layer and the data normalization layer, and generating a first feature vector according to the first feature vector and the first normalized numerical data; and
a recurrent neural network, coupled to the connected layer, wherein the recurrent neural network generates a first classification result corresponding to the first image data and the first numerical data according to the first feature vector, wherein
the heterogeneous integration module generates a second feature vector according to a second image data and a second numerical data corresponding to a second time point, wherein the second numerical data corresponds to the second image data, wherein
the recurrent neural network generates a second classification result corresponding to the second image data and the second numerical data according to the first feature vector and the second feature vector.

5. The classification device of claim 4, wherein the connected layer concatenates the first feature map and the first normalized numerical data to generate a concatenation data, and generates the first feature vector according to the concatenation data.

6. The classification device of claim 4, wherein the first normalized numerical data is normalized to a value from 0 to 1.

7. A classification method based on a neural network, comprising:
obtaining a first image data and a first numerical data corresponding to a first time point, wherein the first numerical data corresponds to the first image data;
obtaining a heterogeneous integration module, wherein the heterogeneous integration module comprises a convolutional layer, a data normalization layer, a connected layer and a classification layer;
generating a first feature map according to the first image data by the convolutional layer;
normalizing the first numerical data to generate a first normalized numerical data by the data normalization layer;
generating a first feature vector according to the first feature map and the first normalized numerical data by the connected layer;
generating a first classification result corresponding to the first image data and the first numerical data according to the first feature vector by the classification layer;
obtaining a second image data and a second numerical data corresponding to a second time point, wherein the second numerical data corresponds to the second image data;
generating a second classification result according to the second image data and the second numerical data by the heterogeneous integration module;
obtaining a recurrent neural network; and
generating a third classification result corresponding to the second image data and the second numerical data according to the first classification result and the second classification result by the recurrent neural network.

8. The classification method of claim 7, wherein the connected layer concatenates the first feature map and the first normalized numerical data to generate a concatenation data, and generates the first feature vector according to the concatenation data.

9. The classification method according to claim 7, wherein the first normalized numerical data is normalized to a value from 0 to 1.

10. A classification method based on a neural network, comprising:
obtaining a first image data and a first numerical data corresponding to a first time point, wherein the first numerical data corresponds to the first image data;
obtaining a heterogeneous integration module and a recurrent neural network, wherein the heterogeneous integration module comprises a convolutional layer, a data normalization layer and a connected layer;
generating a first feature map according to the first image data by the convolutional layer;
normalizing the first numerical data to generate a first normalized numerical data by the data normalization layer;
generating a first feature vector according to the first feature map and the first normalized numerical data by the connected layer;
generating a first classification result corresponding to the first image data and the first numerical data according to the first feature vector by the recurrent neural network;
obtaining a second image data and a second numerical data corresponding to a second time point, wherein the second numerical data corresponds to the second image data;
generating a second feature vector according to the second image data and the second numerical data by the heterogeneous integration module; and
generating a second classification result corresponding to the second image data and the second numerical data according to the first feature vector and the second feature vector by the recurrent neural network.

11. The classification method of claim 10, wherein the connected layer concatenates the first feature map and the first normalized numerical data to generate a concatenation data, and generates the first feature vector according to the concatenation data.

12. The classification method according to claim 10, wherein the first normalized numerical data is normalized to a value from 0 to 1.
